(19) United States
(12) Patent Application Publication
(10) Pub. No.: US 2025/0335321 A1
(43) Pub. Date: Oct. 30, 2025

(54) SYSTEMS AND METHODS FOR TESTING UNIVERSAL SERIAL BUS DEVICES

(71) Applicant: Meta Platforms Technologies, LLC, Menlo Park, CA (US)

(72) Inventors: Lang Yao, San Jose, CA (US); Wenhua Zhou, Shanghai (CN); Xiaofeng Jiang, Shanghai (CN); Minzhi Li, Santa Clara, CA (US); Xiaodong Zhang, Cupertino, CA (US)

(21) Appl. No.: 19/188,585

(22) Filed: Apr. 24, 2025

Related U.S. Application Data
(60) Provisional application No. 63/638,532, filed on Apr. 25, 2024.

(51) Int. Cl. G06F 11/30; G06F 13/38; G06F 13/40

(52) U.S. Cl. CPC G06F 11/3027; G06F 11/3058; G06F 11/3093; G06F 13/382; G06F 13/4072; G06F 2211/002; G06F 2213/0042

(57) ABSTRACT

As disclosed herein, an electronic adapter for facilitating testing of a Universal Serial Bus Type-C device is provided. The adapter may include a first Universal Serial Bus (USB) port for removably coupling with a host device. The adapter may include a USB connector for removably coupling with a first peripheral device. The USB connector may include a first row of pins and a second row of pins. The adapter may include at least one integrated circuit configured to digitally switch between using the first set of pins and the second set of pins to enable a communication between the host device and the first peripheral device. A method, a system, and a non-transitory computer-readable storage medium are also disclosed.

### CROSS-REFERENCE TO RELATED APPLICATIONS

This application claims the benefit of U.S. Provisional Patent Application No. 63/638,532 filed on Apr. 25, 2024, the disclosures of all of these applications and patents are incorporated by reference herein.

### BACKGROUND

### Field

The present disclosure generally relates to embedded systems engineering. More particularly, the present disclosure relates to a Universal Serial Bus Type-C (USB-C) adapter configured to digitally switch between the two rows of USB-C connector pins of the adapter when testing a peripheral USB-C device.

### Related Art

The Universal Serial Bus (USB) Type-C (USB-C) connector has quickly emerged as the standard interface for many modern electronic devices. With a compact, reversible design capable of supporting multiple protocols (e.g., USB 2.x, USB 3.x), power delivery, and video output, USB-C has gained widespread adoption across smartphones, laptops, tablets, and a variety of peripheral devices (e.g., mixed reality headsets). As the number of devices that utilize the USB-C standard continues to grow, so too does the complexity of testing and verifying the functionality of the various USB-C port pins of a device, which may serve different purposes depending on the mode of operation (e.g., data transmission, power delivery, video output, etc.).

### SUMMARY

The subject disclosure provides for systems and methods for a USB-C adapter configured to digitally switch between the two rows of USB-C connector pins of the adapter when testing the functionality of the USB-C port pins of a peripheral device. The adapter may enable testing of all USB-C port pins of the peripheral device without the need for multiple USB-C connectors or physical reconfiguration of a USB-C connector (e.g., flipping the connector into an opposite orientation).

According to certain aspects of the present disclosure, an electronic adapter for facilitating communication between Universal Serial Bus Type-C devices is provided. The electronic adapter may include a first Universal Serial Bus (USB) port for removably coupling with a host device. The electronic adapter may include a USB connector for removably coupling with a first peripheral device. The USB connector may include a first row of pins and a second row of pins. The electronic adapter may include at least one integrated circuit configured to digitally switch between using the first set of pins and the second set of pins to enable a communication between the host device and the first peripheral device.

According to another aspect of the present disclosure, a method for facilitating communication between Universal Serial Bus Type-C devices is provided. The method may include detecting, at a first Universal Serial Bus (USB) port of an electronic device, a removable coupling with a host device. The method may include detecting, at a USB connector of the electronic device, a removable coupling with a first peripheral device. The USB connector may include a first set of pins and a second set of pins. The method may include enabling a communication between the host device and the first peripheral device using one or more pins of the first set of pins. The method may include receiving, from the host device, a request to enable the communication between the host device and the first peripheral device using one or more pins of the second set of pins. The method may include enabling, based on the request, the communication between the host device and the first peripheral device using one or more of the second set of pins.

According to another aspect of the present disclosure, a system is provided. The system may include one or more processors. The system may include one or more memories coupled to at least one of the one or more processors, wherein the one or more memories comprise computer-readable program instructions, which when executed by at least one of the one or more processors, cause the system to detect, at a first Universal Serial Bus (USB) port of an electronic device, a removable coupling with a host device. The instructions, which when executed by at least one of the one or more processors, may cause the system to detect at a USB connector of the electronic device, a removable coupling with a first peripheral device. The USB connector may include a first set of pins and a second set of pins. The instructions, which when executed by at least one of the one or more processors, may cause the system to enable a communication between the host device and the first peripheral device using one or more pins of the first set of pins. The instructions, which when executed by at least one of the one or more processors, may cause the system to receive, from the host device, a request to enable the communication between the host device and the first peripheral device using one or more pins of the second set of pins. The instructions, which when executed by at least one of the one or more processors, may cause the system to enable, based on the request, the communication between the host device and the first peripheral device using one or more of the second set of pins.

According to yet other aspects of the present disclosure, a non-transitory computer-readable storage medium including computer-readable instructions embodied therein, is provided. The instructions, which when executed by the one or more processors, may cause the computer system to detect, at a first Universal Serial Bus (USB) port of an electronic device, a removable coupling with a host device. The instructions, which when executed by the one or more processors, may cause the computer system to detect at a USB connector of the electronic device, a removable coupling with a first peripheral device. The USB connector may include a first set of pins and a second set of pins. The instructions, which when executed by the one or more processors, may cause the computer system to enable a communication between the host device and the first peripheral device using one or more pins of the first set of pins. The instructions, which when executed by the one or more processors, may cause the computer system to receive, from the host device, a request to enable the communication between the host device and the first peripheral device using one or more pins of the second set of pins. The instructions, which when executed by the one or more processors, may cause the computer system to enable, based on the request, the communication between the host device and the first peripheral device using one or more of the second set of pins.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A is an exemplary USB-C pinout included in a USB-C adapter configured to enable digital switching between a first row and a second row of pins of the USB-C connector of the adapter, according to some embodiments;

FIG. 1B is a front view of a USB-C adapter configured to enable digital switching between a first row and a second row of USB-C connector pins of the adapter, according to some embodiments;

FIG. 1C is a side view of the USB-C adapter of FIG. 1B, according to some embodiments;

FIG. 1D is a perspective view of the USB-C adapter of FIG. 1B, according to some embodiments;

FIG. 1E is an exploded perspective view of the USB-C adapter of FIG. 1B, according to some embodiments;

FIGS. 2A-2C illustrate example use cases for implementing a USB-C adapter to facilitate communication between a host device and a device under test (DUT), according to some embodiments;

FIG. 3 is an illustration of an example testing configuration for a device under test using a USB-C adapter, according to some embodiments;

FIG. 4 is a block diagram of modules of an example USB-C adapter configured to enable digital switching between a first row and a second row of USB-C connector pins of the adapter, according to some embodiments;

FIGS. 5 and 6 include example devices under test (DUTs), an augmented reality system and a virtual reality system, according to some embodiments;

FIGS. 7A and 7B include a state diagram showing the transitions between five states of a USB-C adapter configured to enable digital switching between a first row and a second row of USB-C connector pins of the adapter, according to some embodiments;

FIG. 8 is a flowchart illustrating operations in a method for facilitating communication between Universal Serial Bus Type-C devices, according to some embodiments; and

FIG. 9 is a block diagram illustrating an exemplary computer system with which electronic devices, modules, steps, or operations disclosed herein may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

The Universal Serial Bus (USB) Type-C (USB-C) connector has quickly emerged as the standard interface for many modern electronic devices. With a compact, reversible design capable of supporting multiple protocols (e.g., USB 2.x, USB 3.x), power delivery, and video output, USB-C has gained widespread adoption across smartphones, laptops, tablets, and a variety of peripheral devices (e.g., mixed reality headsets). As the number of devices that utilize the USB-C standard continues to grow, so too does the complexity of testing and verifying the functionality of the various USB-C port pins of a device, which may serve different purposes depending on the mode of operation (e.g., data transmission, power delivery, video output, etc.).

A USB-C connector (or plug) and a USB-C port (or receptacle) include twenty-four pins divided into two rows. The twenty-four pins of a USB-C connector may be considered Row A, the “top row,” and Row B, the “bottom row.” The port pins of a USB-C peripheral device may be used for different types of signals and power, and each row may serve distinct functions during data transfer, charging, or video output. The specific pin assignments vary depending on the orientation of the cable, as USB-C connectors are reversible, meaning a connector may be inserted into a port in either orientation. As a result, the functionality of each port pin of a USB-C peripheral device must be tested to ensure full compliance with USB-C specifications and to validate the performance of the peripheral device.

Existing solutions for testing USB-C peripherals typically require manually reconfiguring test equipment or physical intervention to probe different pin assignments in the USB-C port of the peripheral. Such a manual approach is cumbersome, time-consuming, and prone to error. Furthermore, such a manual approach is often impractical for testing peripherals that may require multiple configurations or orientations, as such peripherals may require extensive setup and equipment rearrangement for each test. For example, testing a USB-C port of a mixed reality (MR) headset may require setting up several USB-C connectors with various orientations at several separate testing stations (e.g., a USB-C 2.0-enabled connector in the “top row up” orientation, a USB-C 2.0-enabled connector in the “top row down” orientation, a USB-C 3.0-enabled connector in the “top row up” orientation, and a USB-C 3.0-enabled connector in the “top row down” orientation) and/or setting up several USB-C connectors at separate external displays that support video protocols (e.g., DisplayPort, HDMI).

As disclosed herein, novel systems and methods seek to address these limitations in the field of embedded systems engineering by providing for a USB-C adapter configured to digitally switch between the two rows of USB-C connector pins of the adapter when testing the functionality of the USB-C port pins of a peripheral device. The adapter may facilitate comprehensive testing of all USB-C port pins of the peripheral device without the need for physical reconfiguration of the connector (e.g., flipping the connector into an opposite orientation). By allowing for digital control over which row of pins (e.g., Row A or Row B) is actively connected during testing, the adapter enables developers to automate and streamline the testing process.

In an exemplary embodiment, a user may connect a USB-C adapter, via a USB-C port of the adapter, to a host device (e.g., a laptop computer), and the user may connect the adapter, via a USB-C connector of the adapter, to a device under test (DUT), such as a mixed reality headset. By a user interface (e.g., a command-line interface) of the host device, a user may input a request for the adapter to switch between the first and second rows of the connector pins. For example, with the top or bottom rows of connector pins enabled, the user may input a request to test the corresponding USB 2.x or USB 3.x pins of the DUT. The digital switching mechanism of the adapter may allow for the simulation of various connection scenarios across different orientations, ensuring that all twenty-four DUT port pins may be validated without physical intervention by the user. By eliminating the need to manually swap or rearrange USB-C cables, the systems and methods disclosed herein accelerate the testing process, reduce the risk of errors, and improve the accuracy of test results.

In some embodiments, the USB-C adapter may be configured to collect universal asynchronous receiver-transmitter (UART) logs in parallel with Android Debug Bridge (ADB) communication. In some embodiments, the USB-C adapter may provide current or voltage sensing at a bus voltage (VBUS) line. In some embodiments, the USB-C adapter may be configured to perform USB Power Delivery (PD) protocol analysis. In some embodiments, the USB-C adapter may be configured to enable Debug Accessory Mode (DAM). In some embodiments, the USB-C adapter may be configured to enable charging of a DUT via a passthrough USB-C port of the adapter. In some embodiments, the USB-C adapter may monitor DisplayPort Alternate Mode (DP Alt Mode) on a DUT (e.g., a mixed reality headset).

### Terminology

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

### Example System Architecture

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

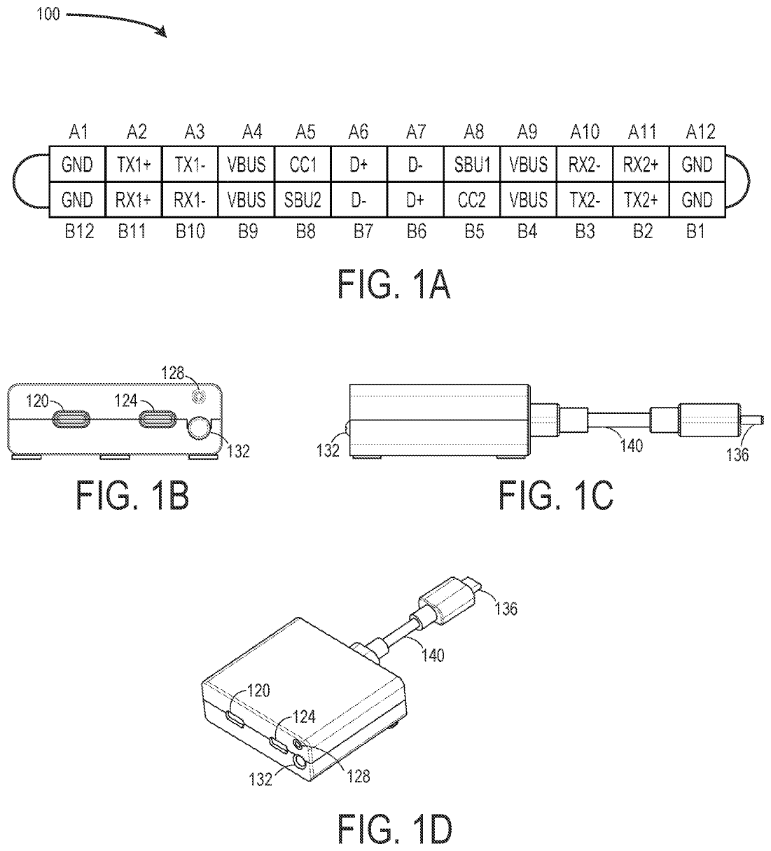

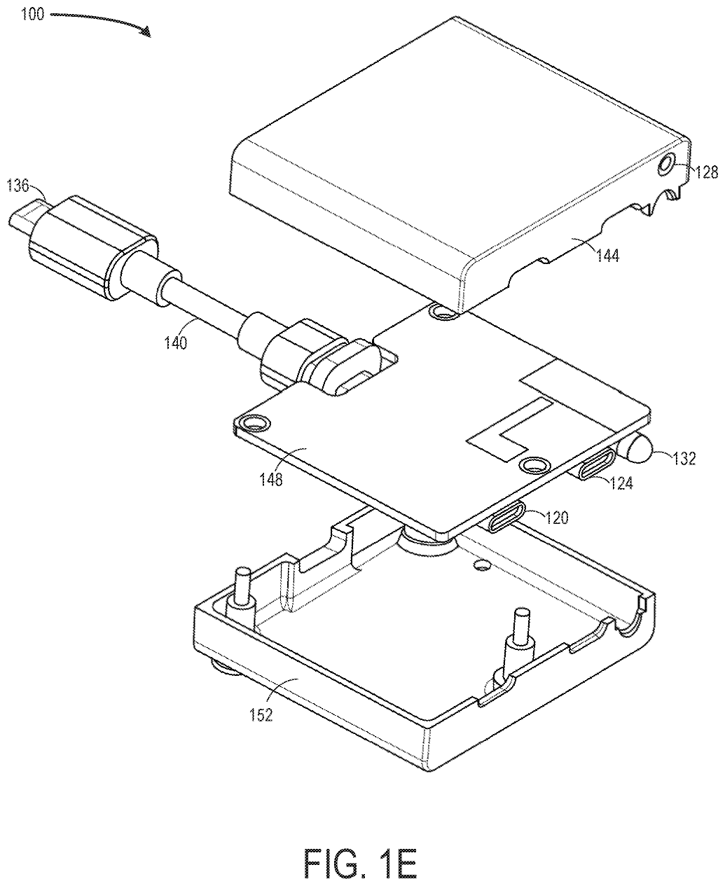

FIG. 1A is an exemplary USB-C pinout included in USB-C adapter 100 configured to enable digital switching between a first row and a second row of USB-C connector pins of the adapter, according to some embodiments. The pinout includes twenty-four (24) pins in two rows of twelve (12): Row A, including pins A1-A12, and Row B, including pins B1-B12. Ground (GND) pins include pins A1, A12, B1, and B12, which provide a return path for electrical signals. Voltage bus (VBUS) pins include pins A4, A9, B4, and B9, which deliver power to connected devices. Pins A6 and B6 (D+) are the positive side of the differential pair for USB 2.0 data transfer. Pins A7 and B7 (D−) are the negative side of the differential pair for USB 2 data transfer. Pins A2 and A3 (TX1+ and TX1−) transmit data for USB 3 on one differential pair. Pins B2 and B3 (TX2+ and TX2−) transmit data for USB 3 on another differential pair. Pins A10 and A11 (RX2− and RX2+) receive data for SuperSpeed USB 3 on one differential pair. Pins B10 and B11 (RX1− and RX1+) receive data for USB 3 on another differential pair. Pins A5 (CC1) and B5 (CC2) are configuration channel pins, which are used for detecting connector (or plug) orientation, negotiating power delivery, and managing alternate modes. Pins A8 (SBU1) and B8 (SBU2) are sideband use pins, which carry auxiliary signals for alternate modes, such as DisplayPort or HDMI.

FIG. 1B is a front view of USB-C adapter 100 configured to enable digital switching between a first row and a second row of USB-C connector pins of the adapter, according to some embodiments. FIG. 1C is a side view of USB-C adapter 100 of FIG. 1B, according to some embodiments. FIG. 1D is a perspective view of USB-C adapter 100 of FIG. 1B, according to some embodiments. FIG. 1E is an exploded perspective view of USB-C adapter 100 of FIG. 1B, according to some embodiments. USB-C adapter 100 includes host USB-C port 120, passthrough USB-C port 124, ground screw 128, status light emitting diode (LED) 132, upper plate 144, lower plate 152, integrated circuit 148, and USB-C cable 140, which includes USB-C connector 136.

Host USB-C port 120 may connect USB-C adapter 100 to a host device, such as a laptop computer or smartphone, via a USB-C cable. Host USB-C port 120 may enable a host device to configure or manage USB-C adapter 100 and to test DUT USB and/or UART paths with reversible orientations. Host USB-C port 120 may facilitate data transfer or power delivery between the host device and USB-C adapter 100, which may draw power from the host device. Passthrough USB-C port 124 may connect USB-C adapter 100 to a peripheral device, such as a power adapter or an external display. Passthrough USB-C port 124 may facilitate power delivery, allowing a device under test (DUT) to charge while undergoing testing by the host device. Ground screw 128 may secure the internal components of USB-C adapter 100 within the housing of the adapter and ensure proper grounding. Grounding may prevent electrical interference and enhance the safety and stability of USB-C adapter 100. Status LED 132 may provide visual feedback about the operational status of USB-C adapter 100. Status LED 132 may indicate power, connectivity, or error states, which may help a user troubleshoot or confirm proper functioning. For example, status LED 132 may be green when a host device and a DUT are communicating normally; may be blue when a host device and a DUT are communicating normally and the DUT is being powered via passthrough USB-C port 124; or may be red when USB-C adapter 100 is functioning abnormally. Upper plate 144 may be the top part of the housing of USB-C adapter 100. Lower plate 152 may be the bottom part of the housing of USB-C adapter 100. Lower plate 152 may include a reset button (not pictured), which may restore USB-C adapter 100 to a default state. Upper plate 144 and lower plate 152 may encase and protect internal components, such as integrated circuit 148, and provide structural integrity. Upper plate 144 and lower plate 152 may be made of durable materials to withstand wear or impact, such as plastics like polycarbonate or acrylonitrile butadiene styrene (ABS). Integrated circuit 148 may include one or more integrated circuits for managing data transfer, power delivery, or other functions between a host device, a DUT, or another peripheral device, such as a power adapter or an external display. USB-C cable 140 may connect USB-C adapter 100 to a DUT, such as a mixed reality headset, by coupling with a USB-C port of the DUT. USB-C cable 140 includes USB-C connector 136, which plugs into the USB-C port of the DUT. USB-C cable 140 may be designed to support high-speed data transfer or power delivery. USB-C cable 140 may be customized to support all twenty-four pins of a standard USB-C port. All twenty-four pins of USB-C connector 136 may be functional, such that the top row of pins or the bottom row of pins may be enabled or disabled for allowing a host device to communicate with a DUT.

In some embodiments, USB-C adapter 100 may have a small form factor (e.g., 5.0 cm×5.0 cm×2.0 cm, or 50 mm×31 mm×20 mm, weighing less than 100 g), which may be suitable for internal or external developer bench setup, lab debugging, or mass production testing. In some embodiments, USB-C cable 140 may be no less than 80 mm in length. In some embodiments, USB-C cable 140 may support an extension cable of up to 1.0 m in length. In some embodiments, host USB-C port 120 and passthrough USB-C port 124 may each support an extension cable of up to 2.0 m in length. USB-C adapter 100 may also be implemented in any other suitable form factor. USB-C adapter 100 may be powered via a connection to a host device, such as a laptop computer or mobile phone. In some embodiments, an additional USB-C port (e.g., passthrough USB-C port 124) may be used to facilitate charging a DUT during development or debugging so that the DUT may not face power loss.

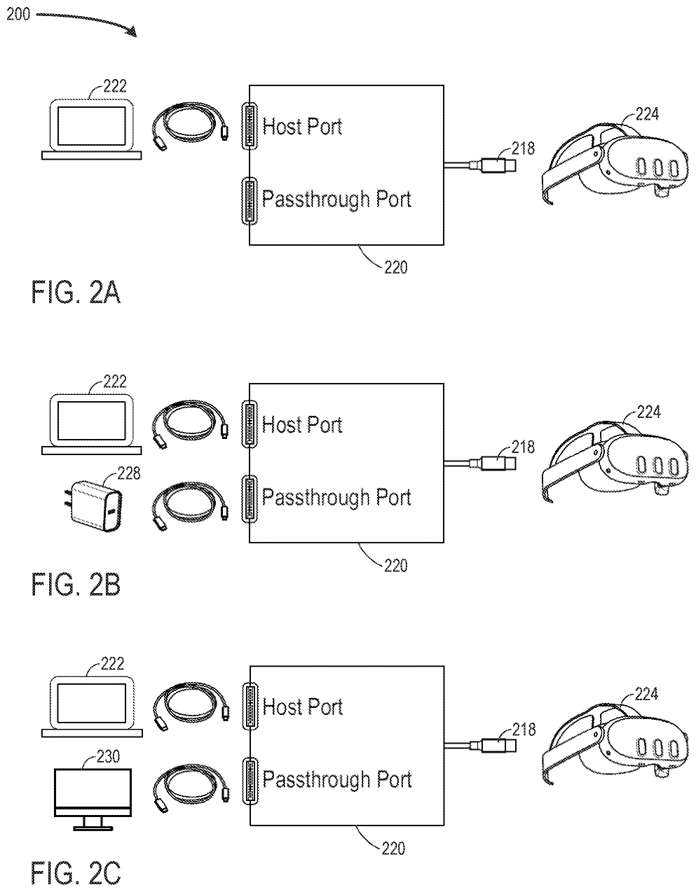

FIGS. 2A-2C illustrate example use cases 200 for implementing a USB-C adapter to facilitate communication between a host device and a device under test (DUT), according to some embodiments. In FIGS. 2A-2C, USB-C connector 218 of USB-C adapter 220 is connected to a first peripheral device, in particular, DUT 224 (shown in FIGS. 2A-2C as a mixed reality headset). FIG. 2A illustrates an example use case wherein the host USB-C port of USB-C adapter 220 is connected to a device (i.e., host device 222) and the passthrough USB-C port of USB-C adapter 220 is not connected to a second peripheral device. FIG. 2B illustrates an example use case wherein the host USB-C port of USB-C adapter 220 is connected to a device (i.e., host device 222) and the passthrough USB-C port of USB-C adapter 220 is connected to a second peripheral device, in particular, power adapter 228. FIG. 2C illustrates an example use case wherein the host USB-C port of USB-C adapter 220 is connected to a device (i.e., host device 222) and the passthrough USB-C port of USB-C adapter 220 is connected to a second peripheral device, in particular, external display 230.

In FIG. 2A, the functionalities supported by USB-C adapter 220 may include management of USB-C adapter 220, including a command-line interface (CLI) of host device 222, upgrading or downgrading the firmware (FW) of USB-C adapter 220, and debug log capturing of DUT 224. The functionalities may further include emulating the reversible USB-C insertion behavior to the DUT 224, controlled by the CLI. The functionalities may further include facilitating and reporting USB Power Delivery (PD) handshake between USB-C adapter 220 to DUT 224, controlled by the CLI. The functionalities may further include VBUS passthrough from host device 222 to DUT 224. The functionalities may further include facilitating the communication between host device 222 to DUT 224 through USB 2.x protocols (e.g., USB 2.0), wherein the path on/off may be controlled by the CLI. The functionalities may further include facilitating the communication between host device 222 to DUT 224 through USB 3.x protocols (e.g., USB 3.0), wherein the path on/off may be controlled by the CLI. The functionalities may further include facilitating the communication between host device 222 to DUT 224 through UART simultaneously with USB 2.x and/or 3.x protocols, wherein the path on/off and flipping may be controlled by the CLI. The functionalities may further include built-in ADC circuitry for VBUS current/voltage (I/V) sensing and logging, reported by the CLI.

In FIGS. 2B and 2C, the functionalities supported by USB-C adapter 220 may include management of USB-C adapter 220, including a command-line interface (CLI) of host device 222, upgrading or downgrading the firmware (FW) of USB-C adapter 220, and debug log capturing of DUT 224. The functionalities may further include facilitating the passthrough between the second peripheral devices to DUT 224, wherein the path on/off may be controlled by the CLI. The functionalities may further include built-in ADC circuitry for VBUS (from the passthrough port to DUT 224), I/V sensing and logging, reported by the CLI. The functionalities may further include USB PD handshake sniffing, reported by the CLI.

Table 1 below includes example CLI commands, along with any arguments (“Args”) for the commands, and descriptions of the commands.

TABLE 1

| CLI Command | Args | Description |
|---|---|---|
| cmds | None | Display all commands |
| set_sms_s1_usb3_cc1 | None | Enable USB3 and CC1 |
| set_sms_s1_usb3_cc2 | None | Enable USB3 and CC2 |
| set_sms_s1_usb2_cc1 | None | Enable USB2 and CC1 |
| set_sms_true_cc_mode | Int | Enable USB2 A/B side switch follow |
| | | CC1/CC2 |
| | | 0: turn off; |
| | | 1: turn on |
| set_host_cc_pp_val | Int | Set pull-up resistor (Rp) at DUT |
| | | port side |
| | | 0: 56K(0.5A); |
| | | 1: 22K(1.5A); |
| | | 2: 10K(3.0A) |
| set_sms_s1_usb2_cc2 | None | Enable USB2 and CC2 |
| set_sms_s1_vbus_off | None | Turn off VBUS |
| sbu_switch_a_side | None | SBU1 (UART TX) match CC1 |
| sbu_switch_b_side | None | SBU1 (UART TX) match CC2 |
| set_sms_s2 | None | Switch to passthrough mode and turn |
| | | on PD sniff |
| test_vit_logging_{—} | Int | 1: turn on VBUS voltage current |
| control | | logging |
| | | 0: turn off VBUS voltage current |
| | | logging |
| | | Output to adapter VI LOG terminal |
| dongle_version | None | Read adapter firmware (FW) version |
| dongle_sn_read | None | Read adapter serial number (SN) |
| dongle_temp | None | Read adapter board temperature |
| dongle_hum | None | Read adapter humidity |
| dfu_reboot | None | Turn adapter into USB device |
| | | firmware upgrade (DFU) mode for |
| | | FW flashing |

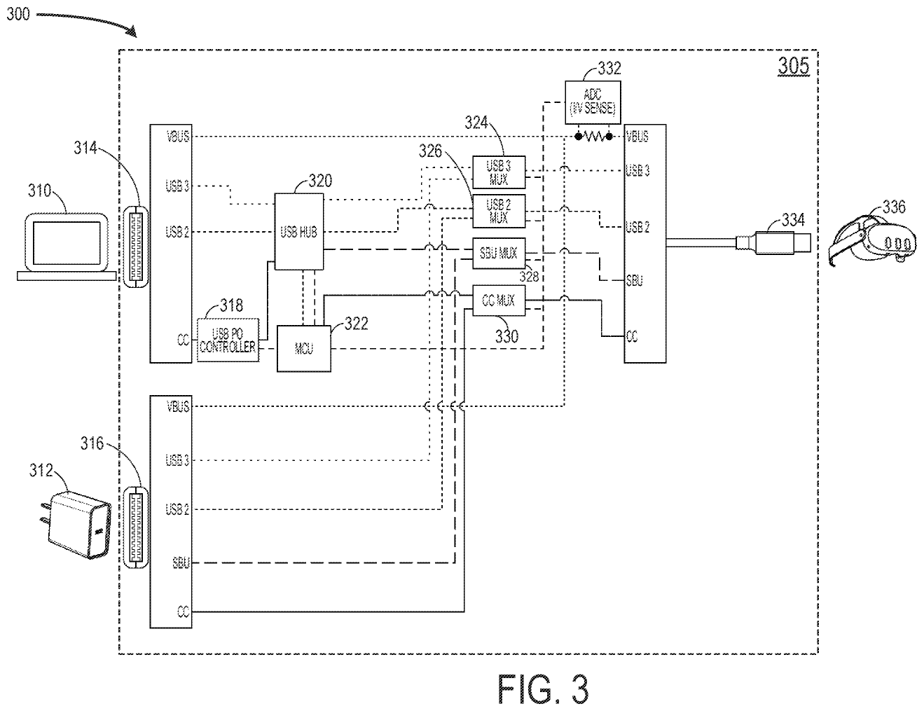

FIG. 3 illustrates an example device under test (DUT) testing configuration 300 using USB-C adapter 305, according to some embodiments. USB-C adapter 305 includes host USB-C port 314, which supports voltage bus (VBUS), USB 3 (e.g., USB 3.0 protocol), USB 2 (e.g., USB 2.0 protocol), and configuration channel (CC) communication. Host device 310 is connected to USB-C adapter 305 via host USB-C port 314. USB-C adapter 305 includes passthrough USB-C port 316, which supports VBUS, USB 3, USB 2, sideband use (SBU), and CC communication. Power adapter 312 is connected to USB-C adapter 305 via passthrough USB-C port 316. USB-C adapter 305 includes USB-C connector 334. DUT 336 (shown as a mixed reality headset) is connected to USB-C adapter 305 via USB-C connector 334.

USB Power Delivery (PD) controller 318 is connected to host USB-C port 314. USB PD controller 318 manages power delivery and communication between host device 310 and other connected devices. Microcontroller unit (MCU) 322 is communicatively coupled to USB PD controller 318. MCU 322 controls the overall operation of USB-C adapter 305, including data routing and power management. USB hub 320 is communicatively coupled to MCU 322. USB-C adapter 305 includes four multiplexers (Mux's): USB 3 Mux 324, for switching between USB 3 signal sources; USB 2 Mux 326, for switching between USB 2 signal sources; SBU Mux 328, for switching between SBU signal sources; and CC Mux 330, for switching between configuration channel signal sources. Analog-to-digital converter (ADC) 332 monitors the VBUS current and voltage and provides feedback to the system.

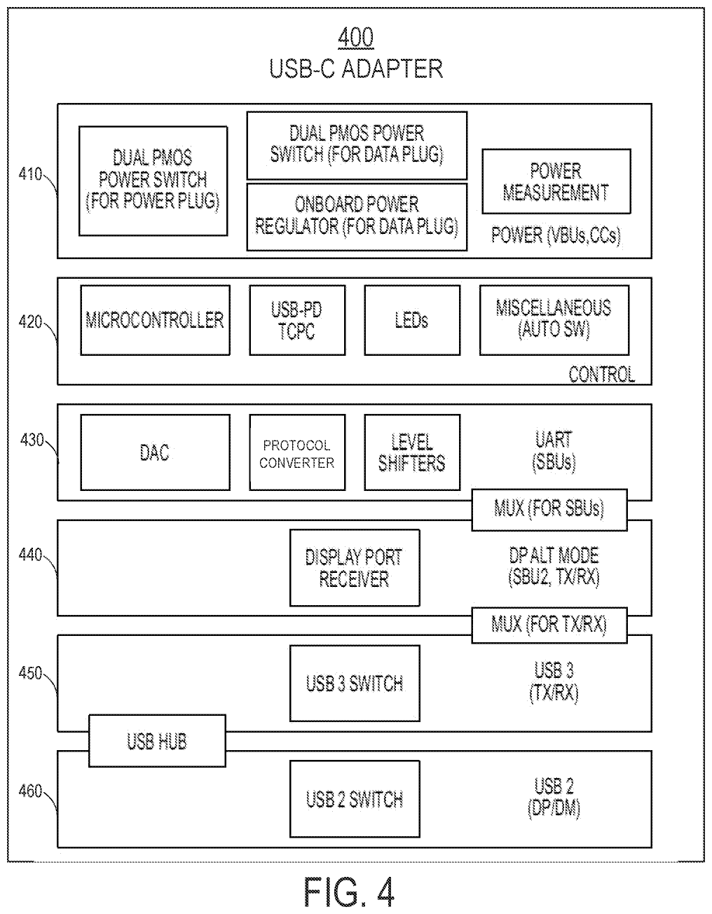

FIG. 4 is a block diagram of modules of an example USB-C adapter 400 configured to enable digital switching between a first row and a second row of USB-C connector pins of the adapter, according to some embodiments. USB-C adapter 400 may include power module 410, control module 420, UART module 430, DisplayPort Alternate Mode (DP Alt Mode) module 440, USB 3 module 450, and USB 2 module 460.

Power module 410 may be configured to send and receive signals from at least USB-C voltage bus (VBUS) and configuration channel (CC) pins. Power module 410 may be configured to include functionality for dual PMOS power switching for a power USB-C cable (or plug), for dual PMOS power switching for a data USB-C cable (or plug), for onboard power regulating for a data plug, and for power measurement. A dual PMOS power switch (for power plug) tool may manage power switching for a USB-C power cable (or plug), ensuring proper power delivery via the power cable (or plug). A dual PMOS power switch (for data plug) may manage power switching for a USB-C data plug. An onboard power regulator (for data plug) tool may regulate power supplied to a USB-C data plug, ensuring stable voltage and current levels. A power measurement tool may measure power parameters such as voltage and current on VBUS and CC lines.

Control module 420 may be configured to include functionality for managing a microcontroller, a USB power delivery (PD) system, including a USB Type-C port controller (TCPC), light-emitting diodes (LEDs), and miscellaneous operations, such as automatic switching. A microcontroller may act as the central processing unit controlling various operations within USB-C adapter 400. A USB-PD TCPC tool may manage communication over USB Power Delivery (PD) protocol for negotiating power delivery contracts. An LED tool may manage status information through one or more LEDs. A miscellaneous (auto SW) tool may manage miscellaneous automatic switching tasks within USB-C adapter 400.

UART module 430 may be configured to send and receive signals from at least USB-C sideband use (SBU) pins. UART module 430 may be configured to include functionality for digital-to-analog converting (DAC), protocol converting (e.g., USB to UART or RS232), and level shifting. A digital-to-analog converter (DAC) tool may be used for converting digital signals into analog form where necessary. A protocol converter tool may be used to convert between USB and serial communication protocols, often used in debugging or interfacing with other devices, such as a DUT. A level shifters tool may adjust signal levels between different components to ensure compatibility in communication interfaces.

DisplayPort Alternate Mode (DP Alt Mode) module 440 may be configured to send and receive signals from at least USB-C SBU2 and transmit/receive (TX/RX) pins. DP Alt Mode module 440 may include functionality for at least a DisplayPort receiver. A DisplayPort receiver tool may receive or monitor DisplayPort video signals from connected devices, such as a DUT.

USB 3 module 450 may be configured to send and receive signals from at least USB-C TX/RX pins. USB 3 module 450 may be configured to include functionality for USB 3 switching, such as switching between TX/RX pins of Row A or Row B. A USB 3 switch tool may manage connections and routing of data through USB 3.x protocols.

USB 2 module 460 may be configured to send and receive signals from at least USB-C differential pins D+ (DP) and D− (DM). USB 2 module 460 may be configured to include functionality for USB 2 switching, such as switching between D+/D− pins of Row A or Row B. A USB 2 switch tool may manage connections and routing of data through USB 2.x protocols.

USB-C adapter 400 may be configured to include multiplexer functionality for selecting between SBU signals of UART module 430 and DP Alt Mode module 440. USB-C adapter 400 may be configured to include multiplexer functionality for selecting between TX/RX signals of DP Alt Mode module 440 and USB 3 module 450.

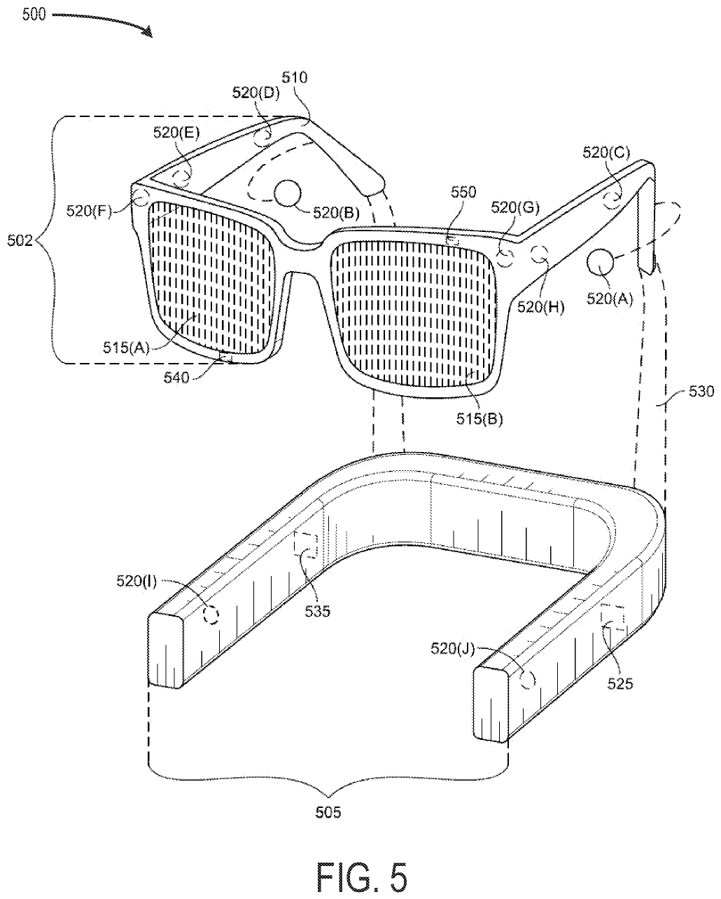

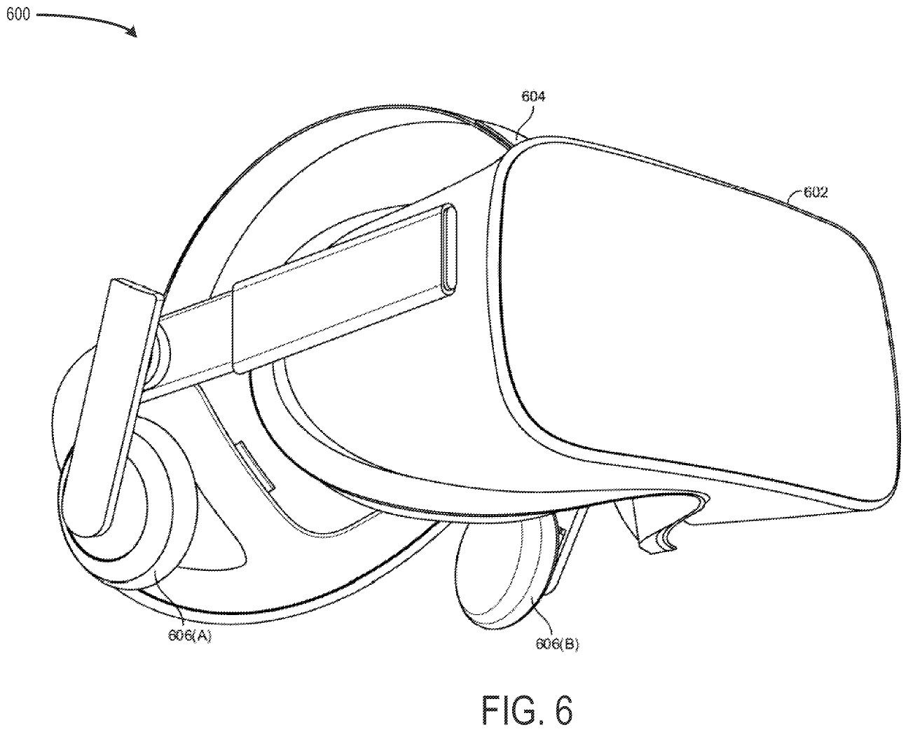

FIGS. 5 and 6 include example devices under test (DUTs), augmented reality system 500 and virtual reality system 600, according to some embodiments. Augmented reality system 500 may include an eyewear device 502 with a frame 510 configured to hold a left display device 515(A) and a right display device 515(B) in front of the eyes of a user. Display devices 515(A) and 515(B) may act together or independently to present an image or series of images to a user. While augmented reality system 500 includes two displays, embodiments of this disclosure may be implemented in augmented reality systems with a single NED or more than two NEDs.

In some embodiments, augmented reality system 500 may include one or more sensors, such as sensor 540. Sensor 540 may generate measurement signals in response to motion of augmented reality system 500 and may be located on substantially any portion of frame 510. Sensor 540 may represent one or more of a variety of different sensing mechanisms, such as a position sensor, an inertial measurement unit (IMU), a depth camera assembly, a structured light emitter and/or detector, or any combination thereof. In some embodiments, augmented reality system 500 may or may not include sensor 540 or may include more than one sensor. In embodiments in which sensor 540 includes an IMU, the IMU may generate calibration data based on measurement signals from sensor 540. Examples of sensor 540 may include, without limitation, accelerometers, gyroscopes, magnetometers, other suitable types of sensors that detect motion, sensors used for error correction of the IMU, or some combination thereof.

In some examples, augmented reality system 500 may also include a microphone array with a plurality of acoustic transducers 520(A)-520(J), referred to collectively as acoustic transducers 520. Acoustic transducers 520 may represent transducers that detect air pressure variations induced by sound waves. Each acoustic transducer 520 may be configured to detect sound and convert the detected sound into an electronic format (e.g., an analog or digital format). The microphone array in FIG. 5 may include, for example, ten acoustic transducers: 520(A) and 520(B), which may be designed to be placed inside a corresponding ear of the user, acoustic transducers 520(C), 520(D), 520(E), 520(F), 520(G), and 520(H), which may be positioned at various locations on frame 510, and/or acoustic transducers 520(I) and 520(J), which may be positioned on a corresponding neckband 505.

In some embodiments, one or more of acoustic transducers 520(A)-(J) may be used as output transducers (e.g., speakers). For example, acoustic transducers 520(A) and/or 520(B) may be earbuds or any other suitable type of headphone or speaker.

The configuration of acoustic transducers 520 of the microphone array may vary. While augmented reality system 500 is shown in FIG. 5 as having ten acoustic transducers 520, the number of acoustic transducers 520 may be greater or less than ten. In some embodiments, using higher numbers of acoustic transducers 520 may increase the amount of audio information collected and/or the sensitivity and accuracy of the audio information. In contrast, using a lower number of acoustic transducers 520 may decrease the computing power required by an associated controller 550 to process the collected audio information. In addition, the position of each acoustic transducer 520 of the microphone array may vary. For example, the position of an acoustic transducer 520 may include a defined position on the user, a defined coordinate on frame 510, an orientation associated with each acoustic transducer 520, or some combination thereof.

Acoustic transducers 520(A) and 520(B) may be positioned on different parts of the user's ear, such as behind the pinna, behind the tragus, and/or within the auricle or fossa. Or, there may be additional acoustic transducers 520 on or surrounding the ear in addition to acoustic transducers 520 inside the ear canal. Having an acoustic transducer 520 positioned next to an ear canal of a user may enable the microphone array to collect information on how sounds arrive at the ear canal. By positioning at least two of acoustic transducers 520 on either side of a user's head (e.g., as binaural microphones), augmented reality device 500 may simulate binaural hearing and capture a 3D stereo sound field around a user's head. In some embodiments, acoustic transducers 520(A) and 520(B) may be connected to augmented reality system 500 via a wired connection 530, and in other embodiments acoustic transducers 520(A) and 520(B) may be connected to augmented reality system 500 via a wireless connection (e.g., a BLUETOOTH connection). In still other embodiments, acoustic transducers 520(A) and 520(B) may not be used at all in conjunction with augmented reality system 500.

Acoustic transducers 520 on frame 510 may be positioned in a variety of different ways, including along the length of the temples, across the bridge, above or below display devices 515(A) and 515(B), or some combination thereof. Acoustic transducers 520 may also be oriented such that the microphone array is able to detect sounds in a wide range of directions surrounding the user wearing the augmented reality system 500. In some embodiments, an optimization process may be performed during manufacturing of augmented reality system 500 to determine relative positioning of each acoustic transducer 520 in the microphone array.

In some examples, augmented reality system 500 may include or be connected to an external device (e.g., a paired device), such as neckband 505. Neckband 505 generally represents any type or form of paired device. Thus, the following discussion of neckband 505 may also apply to various other paired devices, such as charging cases, smart watches, smart phones, wrist bands, other wearable devices, hand-held controllers, tablet computers, laptop computers, other external compute devices, etc.

As shown, neckband 505 may be coupled to eyewear device 502 via one or more connectors. The connectors may be wired or wireless and may include electrical and/or non-electrical (e.g., structural) components. In some cases, eyewear device 502 and neckband 505 may operate independently without any wired or wireless connection between them. While FIG. 5 illustrates the components of eyewear device 502 and neckband 505 in example locations on eyewear device 502 and neckband 505, the components may be located elsewhere and/or distributed differently on eyewear device 502 and/or neckband 505. In some embodiments, the components of eyewear device 502 and neckband 505 may be located on one or more additional peripheral devices paired with eyewear device 502, neckband 505, or some combination thereof.

Pairing external devices, such as neckband 505, with augmented-reality eyewear devices may enable the eyewear devices to achieve the form factor of a pair of glasses while still providing sufficient battery and computation power for expanded capabilities. Some or all of the battery power, computational resources, and/or additional features of augmented reality system 500 may be provided by a paired device or shared between a paired device and an eyewear device, thus reducing the weight, heat profile, and form factor of the eyewear device overall while still retaining desired functionality. For example, neckband 505 may allow components that would otherwise be included on an eyewear device to be included in neckband 505 since users may tolerate a heavier weight load on their shoulders than they would tolerate on their heads. Neckband 505 may also have a larger surface area over which to diffuse and disperse heat to the ambient environment. Thus, neckband 505 may allow for greater battery and computation capacity than might otherwise have been possible on a stand-alone eyewear device. Since weight carried in neckband 505 may be less invasive to a user than weight carried in eyewear device 502, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 505 may be communicatively coupled with eyewear device 502 and/or to other devices. These other devices may provide certain functions (e.g., tracking, localizing, depth mapping, processing, storage, etc.) to augmented reality system 500. In the embodiment of FIG. 5, neckband 505 may include two acoustic transducers (e.g., 520(I) and 520(J)) that are part of the microphone array (or potentially form their own microphone subarray). Neckband 505 may also include a controller 525 and a power source 535.

Acoustic transducers 520(I) and 520(J) of neckband 505 may be configured to detect sound and convert the detected sound into an electronic format (analog or digital). In the embodiment of FIG. 5, acoustic transducers 520(I) and 520(J) may be positioned on neckband 505, thereby increasing the distance between the neckband acoustic transducers 520(I) and 520(J) and other acoustic transducers 520 positioned on eyewear device 502. In some cases, increasing the distance between acoustic transducers 520 of the microphone array may improve the accuracy of beamforming performed via the microphone array. For example, if a sound is detected by acoustic transducers 520(C) and 520(D) and the distance between acoustic transducers 520(C) and 520(D) is greater than, e.g., the distance between acoustic transducers 520(D) and 520(E), the determined source location of the detected sound may be more accurate than if the sound had been detected by acoustic transducers 520(D) and 520(E).

Controller 525 of neckband 505 may process information generated by the sensors on neckband 505 and/or augmented reality system 500. For example, controller 525 may process information from the microphone array that describes sounds detected by the microphone array. For each detected sound, controller 525 may perform a direction-of-arrival (DOA) estimation to estimate a direction from which the detected sound arrived at the microphone array. As the microphone array detects sounds, controller 525 may populate an audio data set with the information. In embodiments in which augmented reality system 500 includes an inertial measurement unit, controller 525 may compute all inertial and spatial calculations from the IMU located on eyewear device 502. A connector may convey information between augmented reality system 500 and neckband 505 and between augmented reality system 500 and controller 525. The information may be in the form of optical data, electrical data, wireless data, or any other transmittable data form. Moving the processing of information generated by augmented reality system 500 to neckband 505 may reduce weight and heat in eyewear device 502, making it more comfortable to the user.

Power source 535 in neckband 505 may provide power to eyewear device 502 and/or to neckband 505. Power source 535 may include, without limitation, lithium-ion batteries, lithium-polymer batteries, primary lithium batteries, alkaline batteries, or any other form of power storage. In some cases, power source 535 may be a wired power source. Including power source 535 on neckband 505 instead of on eyewear device 502 may help better distribute the weight and heat generated by power source 535.

As noted, some artificial reality systems may, instead of blending an artificial reality with actual reality, substantially replace one or more of a user's sensory perceptions of the real world with a virtual experience. One example of this type of system is a head-worn display system, such as virtual reality system 600 in FIG. 6, that mostly or completely covers a user's field of view. Virtual reality system 600 may include a front rigid body 602 and a band 604 shaped to fit around a user's head. Virtual reality system 600 may also include output audio transducers 606(A) and 606(B). Furthermore, while not shown in FIG. 6, front rigid body 602 may include one or more electronic elements, including one or more electronic displays, one or more inertial measurement units (IMUs), one or more tracking emitters or detectors, and/or any other suitable device or system for creating an artificial-reality experience.

Artificial reality systems may include a variety of types of visual feedback mechanisms. For example, display devices in augmented reality system 500 and/or virtual reality system 600 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user's refractive error. Some of these artificial reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented reality system 500 and/or virtual reality system 600 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented reality system 500 and/or virtual reality system 600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

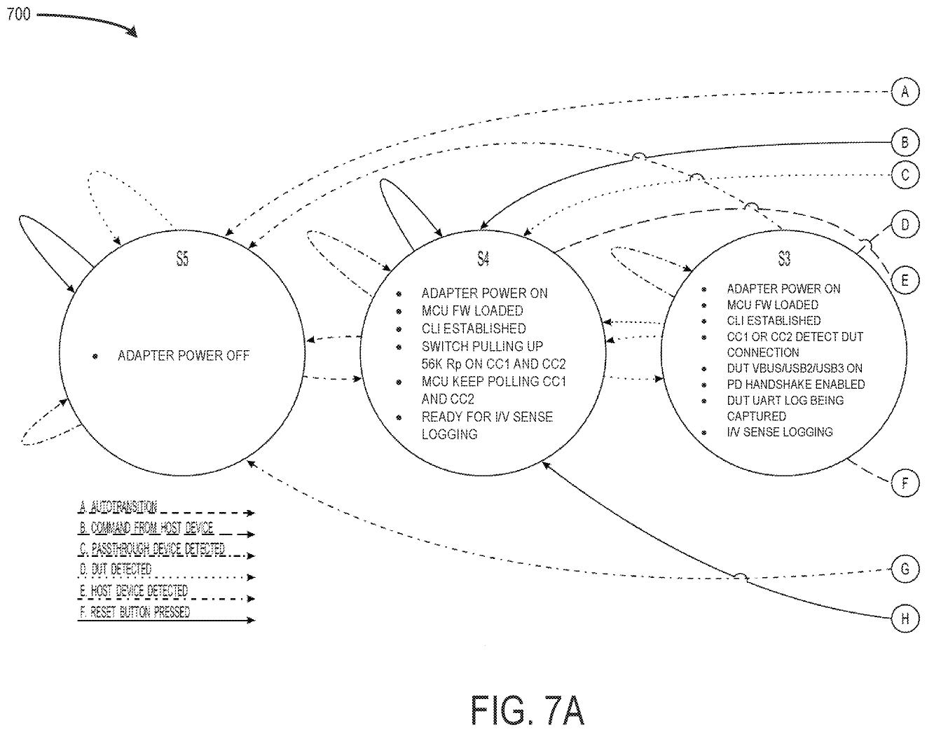

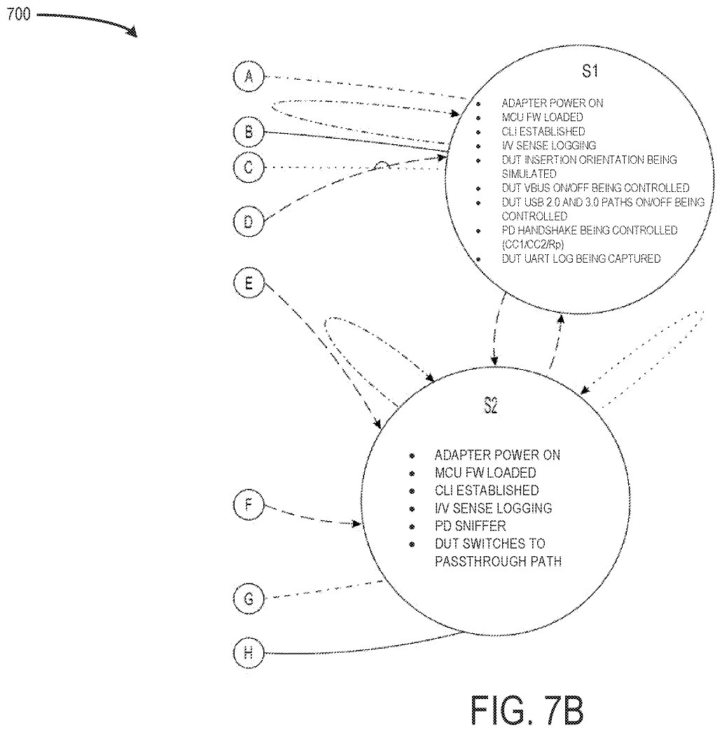

FIGS. 7A and 7B illustrate state diagram 700 showing the transitions between five (5) states of a USB-C adapter configured to enable digital switching between a first row and a second row of USB-C connector pins of the adapter, according to some embodiments. The five (5) states include state five (S5), state four (S4), state three (S3), state two (S2), and state one (S1). Transitions between states may be triggered by the following events: (A.) auto-transition; (B.) command from host device; (C.) passthrough device detected; (D.) device under test (DUT) detected; (E.) host device detected; and (F.) reset button pressed.

Conditions or behaviors associated with state five (S5) may include the following: adapter power off.

Conditions or behaviors associated with state four (S4) may include the following: adapter power on; microcontroller unit (MCU) firmware (FW) loaded; command-line interface (CLI) established; switch pulling up 56K pull-up resistor (Rp) on CC1 and CC2; MCU keeps polling CC1 and CC2; and ready for current/voltage (I/V) sense logging.

Conditions or behaviors associated with state three (S3) may include the following: adapter power on; microcontroller unit (MCU) firmware (FW) loaded; command-line interface (CLI) established; CC1 or CC2 detect device under test (DUT) connection; DUT VBUS/USB2/USB3 on; USB-C Power Delivery (PD) handshake enabled; DUT UART log being captured; and current/voltage (I/V) sense logging.

Conditions or behaviors associated with state two (S2) may include the following: adapter power on; microcontroller unit (MCU) firmware (FW) loaded; command-line interface (CLI) established; current/voltage (I/V) sense logging; USB-C Power Delivery (PD) sniffer; and device under test (DUT) switches to passthrough path.

Conditions or behaviors associated with state one (S1) may include the following: adapter power on; microcontroller unit (MCU) firmware (FW) loaded; command-line interface (CLI) established; current/voltage (I/V) sense logging; device under test (DUT) insertion orientation being simulated; DUT VBUS on/off being controlled; DUT USB 2.0 and 3.0 paths on/off being controlled; USB-C Power Delivery (PD) handshake being controlled (CC1/CC2/Rp); and DUT UART log being captured.

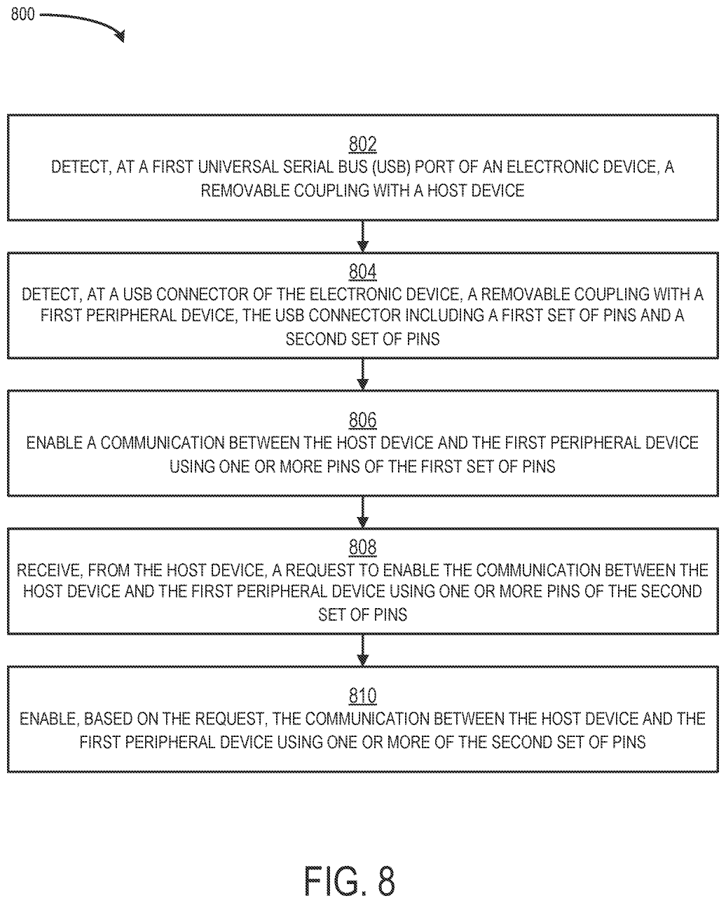

FIG. 8 is a flowchart illustrating operations in a method 800 for facilitating communication between Universal Serial Bus Type-C devices, according to some embodiments. In some embodiments, processes as disclosed herein may include one or more operations in method 800 performed by a processor circuit executing instructions stored in a memory circuit, in a client device, a remote server, or a database, communicatively coupled through a network. In some embodiments, one or more of the operations in method 800 may be performed by one or more of the systems or modules disclosed herein. In some embodiments, processes consistent with the present disclosure may include at least one or more operations as in method 800 performed in a different order, simultaneously, quasi-simultaneously, or overlapping in time.

Operation 802 may include detecting, at a first Universal Serial Bus (USB) port of an electronic device, a removable coupling with a host device. In some embodiments, the USB port may include a USB Type-C (USB-C) port.

Operation 804 may include detecting, at a USB connector of the electronic device, a removable coupling with a first peripheral device, the USB connector including a first set of pins and a second set of pins. In some embodiments, the first peripheral device may include a mixed reality headset. In some embodiments, the USB connector may include a USB-C connector. In further aspects of the embodiments, operation 804 may include monitoring DisplayPort Alternate Mode (DP Alt Mode) on the mixed reality headset. In further aspects of the embodiments, operation 804 may include detecting, at a second USB port of the electronic device, a removable coupling with a second peripheral device. In some aspects of the embodiments, the second USB port may include a passthrough port enabling the first peripheral device to draw power from the second peripheral device. In some aspects of the embodiments, the electronic device may draw power from at least one of the host device and the second peripheral device.

Operation 806 may include enabling a communication between the host device and the first peripheral device using one or more pins of the first set of pins. In further aspects of the embodiments, operation 806 may include facilitating simultaneous universal asynchronous receiver-transmitter (UART) data transfer and at least one of USB 2 and USB 3 data transfer between the host device and the first peripheral device. In further aspects of the embodiments, operation 806 may include performing at least one of current and voltage sensing. In further aspects of the embodiments, operation 806 may include performing USB Power Delivery (PD) protocol analysis.

Operation 808 may include receiving, from the host device, a request to enable the communication between the host device and the first peripheral device using one or more pins of the second set of pins. In some embodiments, a user interface of the host device may include a command-line interface enabling the user to input the request.

Operation 810 may include enabling, based on the request, the communication between the host device and the first peripheral device using one or more of the second set of pins. In further aspects of the embodiments, operation 810 may include disabling the communication between the host device and the first peripheral device using the one or more pins of the first set of pins.

### Hardware Overview

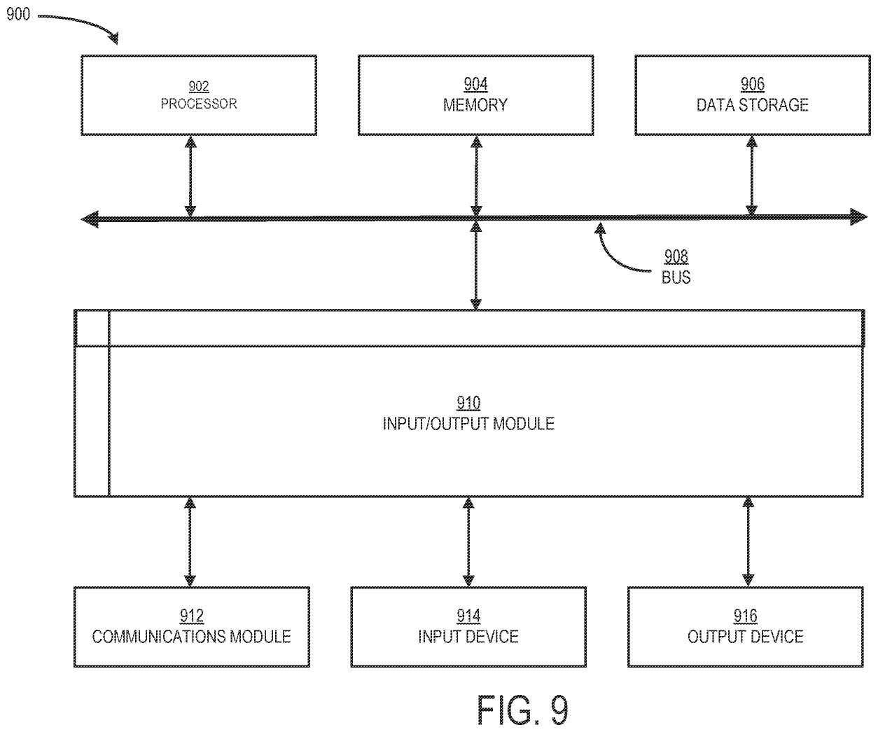

FIG. 9 is a block diagram illustrating an exemplary computer system 900 with which electronic devices, modules, steps, or operations disclosed herein may be implemented, according to some embodiments. In certain aspects, the computer system 900 may be implemented using hardware or a combination of software and hardware, either in a dedicated server, or integrated into another entity, or distributed across multiple entities.

Computer system 900 (e.g., integrated circuit 148) may include bus 908 or another communication mechanism for communicating information, and a processor 902 coupled with bus 908 for processing information. By way of example, computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 900 may include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. Processor 902 and the memory 904 may be supplemented by, or incorporated in, special purpose logic circuitry.

The instructions may be stored in memory 904 and implemented in one or more computer program products, e.g., one or more modules of computer program instructions encoded on a computer-readable medium for execution by, or to control the operation of, computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. Input/output module 910 may be any input/output module. Exemplary input/output modules 910 include data ports such as Universal Serial Bus (USB) ports. The input/output module 910 may be configured to connect to a communications module 912. Exemplary communications modules 912 include networking interface cards, such as Ethernet cards and modems. In certain aspects, input/output module 910 may be configured to connect to a plurality of devices, such as an input device 914 and/or an output device 916. Exemplary input devices 914 include a keyboard and a pointing device, e.g., a mouse or a trackball, by which a user may provide input to computer system 900. Other kinds of input devices 914 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 916 include display devices, such as an LCD (liquid crystal display) monitor, for displaying information to the user.

According to one aspect of the present disclosure, electronic devices, modules, steps, or operations disclosed herein may be implemented using computer system 900 in response to processor 902 executing one or more sequences of one or more instructions contained in memory 904. Such instructions may be read into memory 904 from another machine-readable medium, such as data storage device 906. Execution of the sequences of instructions contained in memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 900 may include clients and servers. A client and server may be generally remote from each other and typically interact through a communication network. The relationship of client and server arises by virtue of computer programs running on the respective computers and having a client-server relationship to each other. Computer system 900 may be, for example, and without limitation, a desktop computer, laptop computer, or tablet computer. Computer system 900 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires forming bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. An electronic device for facilitating communication between Universal Serial Bus Type-C devices, comprising:
a first Universal Serial Bus (USB) port for removably coupling with a host device;
a USB connector for removably coupling with a first peripheral device, the USB connector including a first set of pins and a second set of pins; and
at least one integrated circuit configured to digitally switch between using the first set of pins and the second set of pins to enable a communication between the host device and the first peripheral device.

2. The electronic device of claim 1, wherein the first USB port includes a USB Type-C (USB-C) port and the USB connector includes a USB-C connector.

3. The electronic device of claim 1, wherein the first peripheral device includes a mixed reality headset.

4. The electronic device of claim 3, wherein the at least one integrated circuit is further configured to monitor DisplayPort Alternate Mode (DP Alt Mode) on the mixed reality headset.

5. The electronic device of claim 1, wherein the at least one integrated circuit is further configured to facilitate simultaneous universal asynchronous receiver-transmitter (UART) data transfer and at least one of USB 2 and USB 3 data transfer between the host device and the first peripheral device.

6. The electronic device of claim 1, wherein the at least one integrated circuit is further configured to perform at least one of current and voltage sensing.

7. The electronic device of claim 1, wherein the at least one integrated circuit is further configured to perform USB Power Delivery (PD) protocol analysis.

8. The electronic device of claim 1, further comprising:
a second USB port for removably coupling with a second peripheral device.

9. The electronic device of claim 8, wherein the second USB port includes a passthrough port enabling the first peripheral device to draw power from the second peripheral device.

10. The electronic device of claim 8, wherein the electronic device draws power from at least one of the host device and the second peripheral device.

11. A method for facilitating communication between Universal Serial Bus Type-C devices, comprising:
detecting, at a first Universal Serial Bus (USB) port of an electronic device, a removable coupling with a host device;
detecting, at a USB connector of the electronic device, a removable coupling with a first peripheral device, the USB connector including a first set of pins and a second set of pins;
enabling a communication between the host device and the first peripheral device using one or more pins of the first set of pins;
receiving, from the host device, a request to enable the communication between the host device and the first peripheral device using one or more pins of the second set of pins; and
enabling, based on the request, the communication between the host device and the first peripheral device using one or more of the second set of pins.

12. The method of claim 11, wherein the first USB port includes a USB Type-C (USB-C) port and the USB connector includes a USB-C connector.

13. The method of claim 11, wherein the first peripheral device includes a mixed reality headset.

14. The method of claim 13, further comprising:
monitoring DisplayPort Alternate Mode (DP Alt Mode) on the mixed reality headset.

15. The method of claim 11, further comprising:
facilitating simultaneous universal asynchronous receiver-transmitter (UART) data transfer and at least one of USB 2 and USB 3 data transfer between the host device and the first peripheral device.

16. The method of claim 11, further comprising:
performing at least one of current and voltage sensing; and
performing USB Power Delivery (PD) protocol analysis.

17. The method of claim 11, further comprising:
detecting, at a second USB port of the electronic device, a removable coupling with a second peripheral device.

18. The method of claim 17, wherein:
the second USB port includes a passthrough port enabling the first peripheral device to draw power from the second peripheral device.

19. The method of claim 17, wherein:
the electronic device draws power from at least one of the host device and the second peripheral device.

20. The method of claim 11, further comprising:
disabling the communication between the host device and the first peripheral device using the one or more pins of the first set of pins.
